(19) United States
(12) Patent Application Publication
(10) Pub. No.: US 2026/0245203 A1
(43) Pub. Date: Aug. 20, 2026

(54) SYSTEM, METHOD, AND APPARATUS FOR ANALYZING X-RAY IMAGES USING MULTI-VIEW CLASSIFICATION

(71) Applicant: MARS, INCORPORATED, McLean, VA (US)

(72) Inventors: Michael Fitzke, Lower Saxony (DE); Andre Dourson, Haguenau (FR)

(73) Assignee: MARS, INCORPORATED, McLean, VA (US)

(21) Appl. No.: 19/159,274

(22) PCT Filed: Feb. 22, 2024
(86) PCT No.: PCT/US2024/016816

§ 371 Date: Aug. 22, 2025

Related U.S. Application Data
(60) Provisional application No. 63/486,569, filed on Feb. 23, 2023.
(60) Provisional application No. 63/488,746, filed on Mar. 6, 2023.

(51) Int. Cl. G06T 7/00; G06N 3/0464

(52) U.S. Cl. CPC G06T 7/0012; G06N 3/0464; G06T 2207/10116; G06T 2207/20084; G06T 2207/30061

(57) ABSTRACT

In one embodiment, a method includes accessing multiple X-ray images associated with an animal, wherein the multiple X-ray images correspond to multiple views, respectively, generating multiple feature maps for the multiple X-ray images, respectively, by a first machine-learning model, and determining diagnosis labels indicating diseases associated with the animal based on the multiple feature maps by a second machine-learning model which includes an attention mechanism.

### CROSS-REFERENCE TO RELATED APPLICATIONS

This application claims the benefit of priority of U.S. Provisional Patent Application No. 63/486,569, filed Feb. 23, 2023, and U.S. Provisional Patent Application No. 63/488,746, filed Mar. 6, 2023, the content of each of which is incorporated herein by reference in its entirety, and to which priority is claimed.

### TECHNICAL FIELD

The embodiments described in the disclosure relate to radiology study for animals. For example, some non-limiting embodiments relate to analyzing X-ray images to help detect a disease of an animal.

### BACKGROUND

Accurate and efficient classification of medical images, such as X-ray images, can be crucial for the diagnosis and treatment of diseases. For example, chest X-ray images are commonly used in medical diagnosis. Over the years, artificial-intelligence (AI) models have been developed to assist with the interpretation of these images. Many AI tools for medical imaging may rely on models that process a single view of the X-ray image. However, it is common for multiple views to be taken during a patient's visit to the radiologist. In veterinary medicine, there is strong evidence that multi-view thoracic radiographic studies can lead to more sensitive results for possible structured interstitial pulmonary disease, including metastatic disease.

Machine learning (ML) is a field of inquiry devoted to understanding and building methods that “learn”, that is, methods that leverage data to improve performance on some set of tasks. It is seen as a part of artificial intelligence. Machine-learning algorithms build a model based on sample data, known as training data, in order to make predictions or decisions without being explicitly programmed to do so. Machine-learning algorithms are used in a wide variety of applications, such as in medicine, email filtering, speech recognition, and computer vision, where it is difficult or unfeasible to develop conventional algorithms to perform the needed task.

### BRIEF SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages, and in accordance with the purpose of the disclosed subject matter, as embodied and broadly described, the disclosed subject matter presents systems, methods, and apparatuses that can be used to collect, receive and/or analyze data. For example, certain non-limiting embodiments can be used to analyze X-ray images of animals.

In certain non-limiting embodiments, the disclosure describes a method for combining information from multiple views to improve the performance of X-ray image classification. The approach can be based on the use of a convolutional neural network to extract feature maps from each view, followed by an attention mechanism implemented using a vision transformer. The presently disclosed subject matter demonstrates the effectiveness of the approach through experiments on a dataset of 363,000 X-ray images. The experimental results show that the resulting model is able to perform multi-label classification on 41 labels and outperforms both single-view models and traditional multi-view classification architectures.

In certain non-limiting embodiments, one or more computing systems can access a plurality of X-ray images associated with an animal. In some non-limiting embodiments, the plurality of X-ray images can correspond to a plurality of views, respectively. The computing systems can then generate, by a first machine-learning model, a plurality of feature maps for the plurality of X-ray images, respectively. The computing systems can further determine, based on the plurality of feature maps by a second machine-learning model, one or more diagnosis labels. In some embodiments, the second machine-learning model can comprise an attention mechanism. In one feature, the one or more diagnosis labels can indicate one or more diseases associated with the animal.

In certain non-limiting embodiments, one or more computer-readable non-transitory storage media embodying software is operable when executed to access a plurality of X-ray images associated with an animal. In some non-limiting embodiments, the plurality of X-ray images can correspond to a plurality of views, respectively. The software is further operable when executed to generate, by a first machine-learning model, a plurality of feature maps for the plurality of X-ray images, respectively. The software is further operable when executed to determine, based on the plurality of feature maps by a second machine-learning model, one or more diagnosis labels. In some non-limiting embodiments, the second machine-learning model can comprise an attention mechanism. In one feature, the one or more diagnosis labels can indicate one or more diseases associated with the animal.

In certain non-limiting embodiments, a system can comprise one or more processors and a non-transitory memory coupled to the processors comprising instructions executable by the processors. The processors are operable when executing the instructions to access a plurality of X-ray images associated with an animal. In some non-limiting embodiments, the plurality of X-ray images can correspond to a plurality of views, respectively. The processors are further operable when executing the instructions to generate, by a first machine-learning model, a plurality of feature maps for the plurality of X-ray images, respectively. The processors are further operable when executing the instructions to determine, based on the plurality of feature maps by a second machine-learning model, one or more diagnosis labels. In some non-limiting embodiments, the second machine-learning model can comprise an attention mechanism. In one feature, the one or more diagnosis labels can indicate one or more diseases associated with the animal.

Furthermore, the disclosed embodiments of the methods, computer readable non-transitory storage media, and systems can have further non-limiting features as described below.

In certain non-limiting embodiments, the plurality of X-ray images can depict one or more organs of the animal.

In certain non-limiting embodiments, the first machine-learning model can be based on one or more convolutional neural networks. In certain non-limiting embodiments, the second machine-learning model can be based on one or more vision transformers. In some embodiments, the second machine-learning model can be based on one or more loss functions comprising one or more of a binary cross entropy or a focal loss.

In certain non-limiting embodiments, the computing systems can concatenate the feature maps to form a tensor. The computing systems can further input the tensor to the second machine-learning model.

In one feature, the one or more diagnosis labels can comprise one or more of pulmonary mass, pulmonary interstitial nodule, or mediastinal mass effect.

In certain non-limiting embodiments, the computing systems can generate one or more attention maps for the plurality of X-ray images. In some embodiments, each of the one or more attention maps can highlight a focused region indicating a disease. It is to be understood that both the foregoing general description and the following detailed description are exemplary and are intended to provide further explanation of the disclosed subject matter claimed.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 illustrates an example architecture of the model;

FIG. 2 illustrates an example sample of the X-ray images used in the present disclosure;

FIG. 3 illustrates example training and validation losses during the ViT-specific training;

FIG. 4 illustrates an example comparison of ROC curves of the pulmonary-mass label for different models;

FIG. 5 illustrates an example attention map of the specific-to-lung-diseases model, of a patient with pulmonary mass;

FIG. 6 illustrates an example attention map focusing on the thorax;

FIG. 7 illustrates another example attention map;

FIG. 8 illustrates another example attention map;

FIG. 9 illustrates an example method for multi-view classification of X-ray images; and

FIG. 10 illustrates an example computer system.

### DESCRIPTION OF EXAMPLE EMBODIMENTS

The present disclosure will now be described more fully hereinafter with reference to the accompanying drawings, which form a part hereof, and which show, by way of illustration, certain example embodiments. Subject matter can, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter can be embodied as methods, devices, components, and/or systems. Accordingly, embodiments can, for example, take the form of hardware, software, firmware or any combination thereof (other than software per se). The following detailed description is, therefore, not intended to be taken in a limiting sense.

The present disclosure provides systems, methods, and/or devices that can take a variable number of X-ray images as input and perform multi-label classification using a model. The architecture of the model can combine a convolutional neural network with an attention mechanism implemented using a vision transformer. This approach can allow the model to extract relevant features from each view and effectively combine them to improve classification performance. The disclosed subject matter demonstrates the effectiveness of the model through experiments on a dataset of 363,000 veterinary X-ray images and show that it outperforms both single-view models and traditional multi-view classification architectures. In addition, the model can accept a variable number of views in any position, making it highly adaptable to a variety of use cases.

In the detailed description herein, references to “embodiment,” “an embodiment,” “one non-limiting embodiment,” “in various embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

In general, terminology can be understood at least in part from usage in context. For example, terms, such as “and”, “or”, or “and/or,” as used herein can include a variety of meanings that can depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, can be used to describe any feature, structure, or characteristic in a singular sense or can be used to describe combinations of features, structures or characteristics in a plural sense. Similarly, terms, such as “a,” “an,” or “the,” again, can be understood to convey a singular usage or to convey a plural usage, depending at least in part upon context. In addition, the term “based on” can be understood as not necessarily intended to convey an exclusive set of factors and can, instead, allow for existence of additional factors not necessarily expressly described, again, depending at least in part on context. As used herein, the words “may” and “can” are used in a permissive sense (i.e., meaning having the potential to), rather than the mandatory sense (i.e., meaning must). Similarly, the words “include”, “including”, and “includes” mean including but not limited to.

As used herein, the terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus.

The terms “animal” or “veterinary” as used in accordance with the present disclosure can refer to domestic animals including, domestic dogs, domestic cats, horses, cows, ferrets, rabbits, pigs, rats, mice, gerbils, hamsters, goats, and the like. The term “animal” or “veterinary” as used in accordance with the present disclosure can also refer to wild animals, including, but not limited to bison, elk, deer, venison, duck, fowl, fish, and the like.

Certain non-limiting embodiments are described below with reference to block diagrams and operational illustrations of methods, processes, devices, and apparatus. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of: a general purpose computer to alter its function to a special purpose; a special purpose computer; ASIC; or other programmable digital data processing apparatus, such that the instructions, which execute via the processor of the computer or other programmable data processing apparatus, implement the functions/acts specified in the block diagrams or operational block or blocks, thereby transforming their functionality in accordance with embodiments herein.

In some non-limiting embodiments, a computer readable medium (or computer-readable storage medium/media) stores computer data, which data can include computer program code (or computer-executable instructions) that is executable by a computer, in machine readable form. By way of example, and not limitation, a computer readable medium can comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

The disclosed subject matter is in the field of multi-view classification, using a concatenation method and feature map augmentation in combination with an attention mechanism based on vision transformers. The model can significantly improve classification performance compared to existing models such as MVCNN-based models.

In recent years, the problem of multi-view classification has received significant attention in the machine-learning community. A common approach for addressing this problem may be to use multi-view convolutional neural network (MVCNN) architectures, which may first process each view independently using a convolutional neural network (CNN), followed by a view pooling step and final classification using either a multi-layer perceptron or another CNN. There have been several studies that have demonstrated the effectiveness of multi-view classification techniques, particularly in the context of X-ray images. The disclosed method builds upon these existing approaches by introducing an attention-based and dynamic mechanism for combining the information from different views.

Transformers have rapidly gained popularity in the field of natural language processing and have emerged as a promising architecture for a variety of tasks. Transformers were adapted for use in computer-vision tasks and have subsequently achieved state-of-the-art performance in image classification. In a vision transformer (ViT) model, images can be decomposed into a sequence of patches which can be transformed into tokens and processed by the transformer. The disclosed method can leverage the effectiveness of vision transformers by incorporating them as a key component of the attention-based and dynamic multi-view classifier for X-ray images.

The presently disclosed subject matter compares its approach with classification models, which were trained on large scale medical image data.

In the presently disclosed subject matter, the method for multi-label classification of X-ray images is provided. The approach can use an adapted vision transformer (ViT) that takes as input features extracted from multiple views of the X-ray images. The features can be extracted using a convolutional neural network (CNN) that can be pretrained on single-view images. The same CNN can be applied to each view to extract features, which can be then concatenated and augmented to form a square matrix. The square matrix can be fed into the ViT to produce the final multi-label classification.

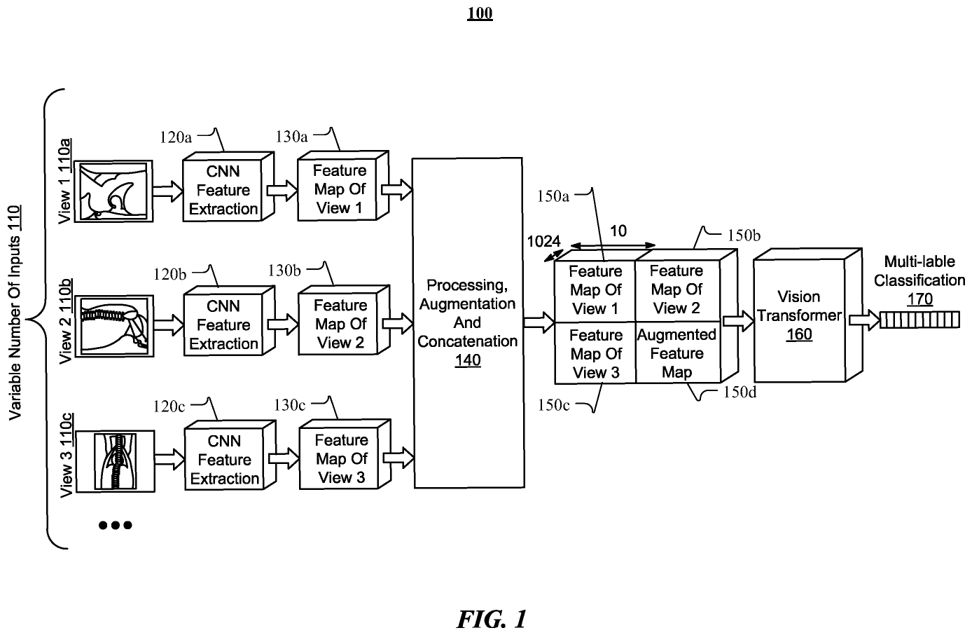

FIG. 1 illustrates an example architecture 100 of the model. In particular embodiments, there may be a variable number of inputs 110 to the architecture 100. The variable number of inputs may comprise a plurality of input X-ray views 110a, 110b, 110c, . . . . As an example and not by way of limitation, each of the input X-ray views can have dimensions of 3×320×320.

In particular embodiments, each of the input X-ray views 110 may be processed by a CNN feature extraction module 120. As an example and not by way of limitation, the CNN used for feature extraction can be based on the Densenet121 architecture (i.e., a conventional CNN architecture) and have pre-trained weights from a model trained for multi-label classification on single views. The output of the CNN feature extraction module 120 may comprise feature maps for the multiple views, e.g., feature map 130a of view 1, feature map 130b of view 2, and feature map 130c of view 3. As an example and not by way of limitation, the output feature maps 130 of the convolutional part can have dimensions 10×10×1024.

In particular embodiments, the features maps 130 may be processed by processing, augmentation and concatenation 140. Data augmentation can be used to generate additional feature maps, if needed, to form a square matrix 150d. The feature maps 130 can be concatenated to form a square with width W, where W is the square root of the total number of feature maps. As illustrated in FIG. 1, a square 150a may correspond to feature map of view 1, a square 150b may correspond to feature map of view 2, and a square 150c may correspond to feature map of view 3. In the present disclosure, the model can be trained for W=2, 3, and 4, and can accept up to 16 views (W=4).

The input to the vision transformer (ViT) 160 can be a matrix of size (W×10, W×10, 1024), which may require adaptation of the vision transformer 160. A patch size of 1, a depth of 6, 16 attention heads, and a multi-layer perceptron (MLP) with dimension of 2048 can be used. In particular embodiments, the vision transformer 160 may utilize a self-attention mechanism to model contextual relationship associated with the input. The vision transformer 160 may predict the multi-label classification 170.

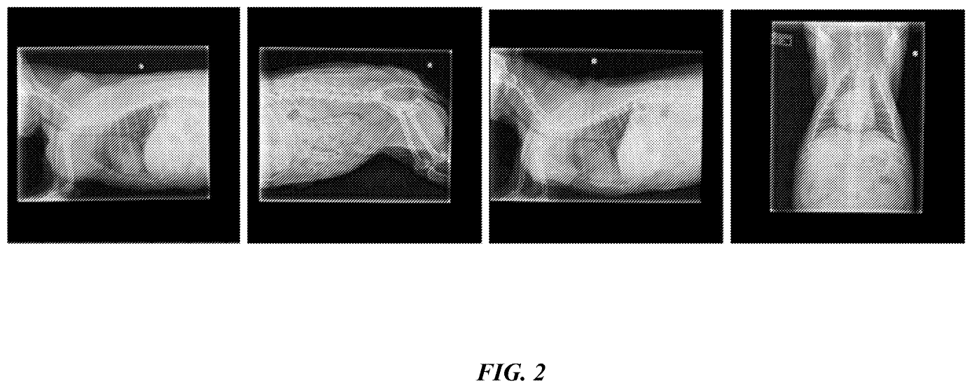

Particular embodiments used example data to train the machine-learning models and evaluate the performance. The example data consists of 390850 X-ray images, taken from 98660 veterinary sessions. These images were annotated by radiologists for over 41 diseases in a multi-label fashion and included feedback from the usage of a radiology learning tool. Additionally, a dataset of 800 images with high-quality annotations was used, where the annotations were performed by 12 radiologists collaborating on each image. FIG. 2 illustrates an example sample of the X-ray images used in the present disclosure.

To ensure unbiased results, the X-ray images can be split into three datasets: train, validation, and test, while considering the fact that the CNN can be previously trained on this dataset. On average, there can be approximately 3.96 images per study, which can range from 1 to more than 10 images sometimes. The total 390850 images can correspond to 98660 studies. The datasets can be split as follows. The train set can consist of 363820 images, or 92434 studies. The validation set can consist of 13515 images, or 3113 studies. The test set can consist of 13481 images, or 3113 studies.

The initial labels can be relative to each X-ray image, but in the present disclosure, labels relative to the studies may be needed. Different views of a study can often have different labels, as some diseases may be visible in some views and not in others. For a given label, its value can be the maximum value of that label among all views of the study. Formally, let L_{i, j, k} be the value of i^{th} label of the kth view of the j^{th} study, and let LS_{i, j} be the study-level label, then:

$${LS}_{i , j} = {max}_{k ∈ 〚 1 , {nb}_{view {s}_{j}} 〛} {L}_{i , j , k} ∀ i ∈ 〚 1 , {nb}_{labels} 〛 ∀ j ∈ 〚 1 , {nb}_{studies} 〛$$

This can reflect the fact that a patient is considered to have a disease if that disease is detected in at least one view of the study.

The preprocessing operations can be consistent with those used in the CNN preprocessing pipeline. When switching to a different CNN, the corresponding preprocessing can be applied. The images can be first converted to tensors and resized to 3×320×320 (channels×height×width), followed by normalization. The normalization can be performed using the ImageNet mean and standard deviation, which are [0.485, 0.456, 0.406] for the mean and [0.229, 0.224, 0.225] for the standard deviation, respectively. During training, data augmentation can be performed using horizontal and vertical flips, as well as a variety of data augmentation methods.

The CNN used can be pre-trained for the specific use case in the present disclosure, and the first training stage can be focused solely on the vision transformer by freezing the CNN weights. This stage may require over 50 epochs and can be performed in several phases by saving the weights and optimizer. Subsequently, the entire network can be trained, including the CNN, for 10 epochs until the validation loss stopped decreasing. Most of the training can be conducted using a GPU and may take approximately 100 hours.

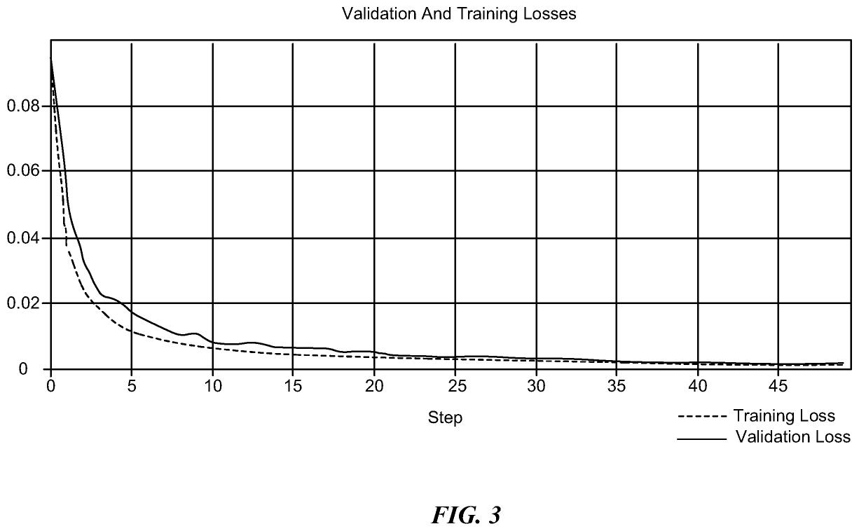

Several loss functions, including the BCE (binary cross entropy) and the focal loss, were evaluated. The focal loss showed promise due to the presence of unbalanced classes, however the results were not better than the BCE. In the present disclosure, the BCE was chosen as the loss function. FIG. 3 illustrates example training and validation losses during the ViT-specific training.

A model can be trained specifically for lung-related diseases, with the goal of improving performance on these labels. The model can classify three diseases: pulmonary mass, pulmonary interstitial nodule, and mediastinal mass effect.

An alternative architecture, based on the multi-view CNN (MVCNN), can be also implemented for comparison. In this architecture, the vision transformer can be replaced by a CNN. The results of the model surpassed the performance of this architecture, as shown in the results described below.

The performance of the original CNN, the multi-view CNN (MVCNN) based architecture, the model, and the lung disease specific model were compared by evaluating their ROC-AUC scores on different diseases. The ROC-AUC scores of the models are presented in Table 1. For the single view CNN model, the maximum score over all views was taken as the output of the CNN for each label.

TABLE 1
ROCAUC scores for different models.
ROC-AUC scores for different models

| | Single View | MVCNN- | | |
|---|---|---|---|---|
| | CNN (Max | based | | Lung-specific |
| Diseases | over views) | model | Model | Model |
| Mediastinal Mass | 0.941 | 0.943 | 0.953 | 0.962 |
| effect | | | | |
| Pulmonary Mass | 0.929 | 0.928 | 0.941 | 0.945 |
| Pulmonary | 0.905 | 0.908 | 0.922 | 0.919 |
| Interstitial Nodules | | | | |
| Signs(s) of IVDD - | 0.913 | 0.915 | 0.940 | / |
| Nodule | | | | |
| Gastric Foreign | 0.865 | 0.864 | 0.898 | / |
| Material (de-bris - | | | | |
| Nodule | | | | |
| Degenerative Joint | 0.838 | 0.839 | 0.848 | / |
| Disease - Nodule | | | | |
| Sign(s) of Pleural | 0.935 | 0.935 | 0.940 | / |
| Effusion - Nodule | | | | |
| Pneumothorax | 0.926 | 0.927 | 0.959 | / |
| Pulmonary Vascular | 0.928 | 0.928 | 0.955 | / |

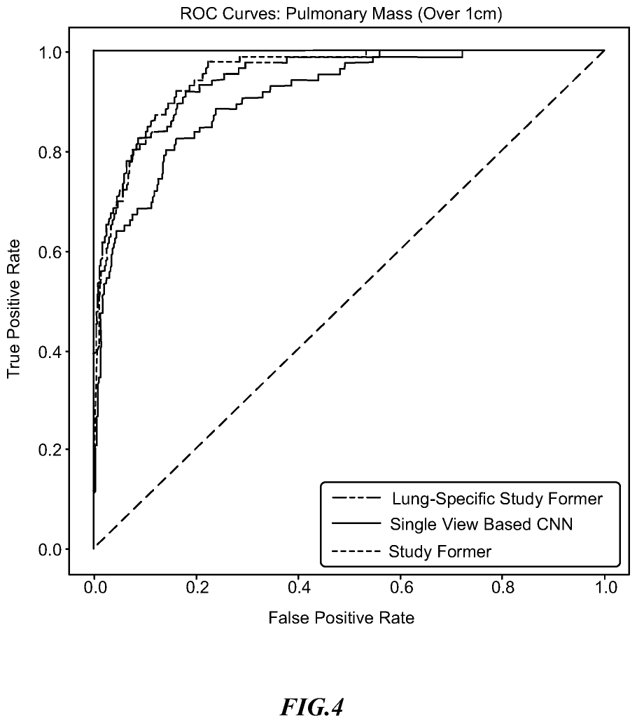

FIG. 4 illustrates an example comparison of ROC curves of the pulmonary-mass label for different models, e.g., a lung-specific StudyFormer 410, a single view based CNN 420, and a StudyFormer 430. The model and specific-model curves are above the single view CNN curve.

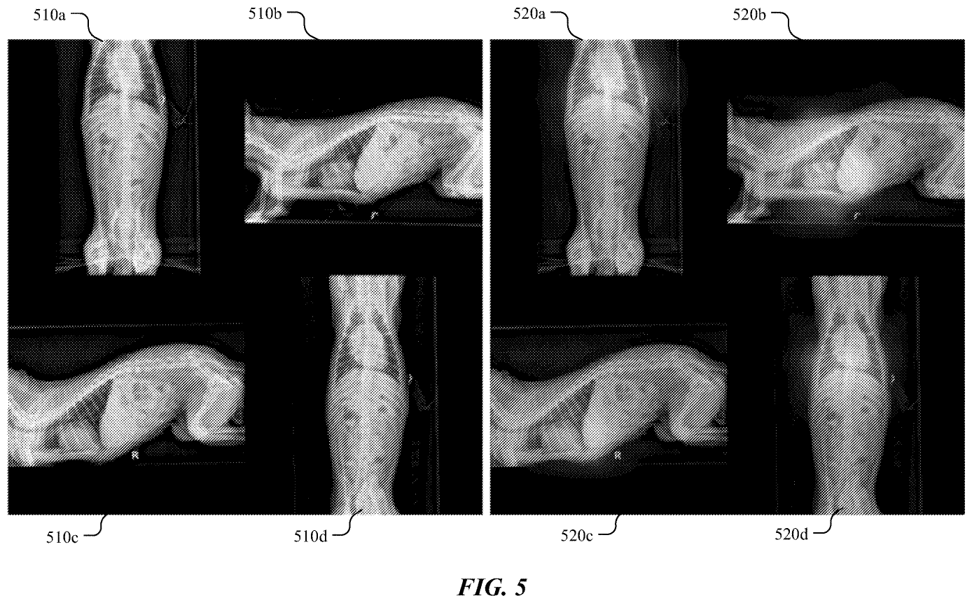

FIGS. 5-8 present visualizations of the vision transformer (ViT) attention maps. The vision transformer used is specific to lung diseases, and the attention maps are shown for patients with the positive label “pulmonary mass”. The input to the vision transformer can be a concatenated feature map, and the X-ray images have been mapped and displayed with the same concatenation and transformations applied to the augmented feature maps.

FIG. 5 illustrates an example attention map of the specific-to-lung-diseases model, of a patient with pulmonary mass. The input X-ray images 510a, 510b, 510c, and 510d depict the body part of the lung from different views. The attention maps are visualized in images 520a, 520b, 520c, and 520d, respectively.

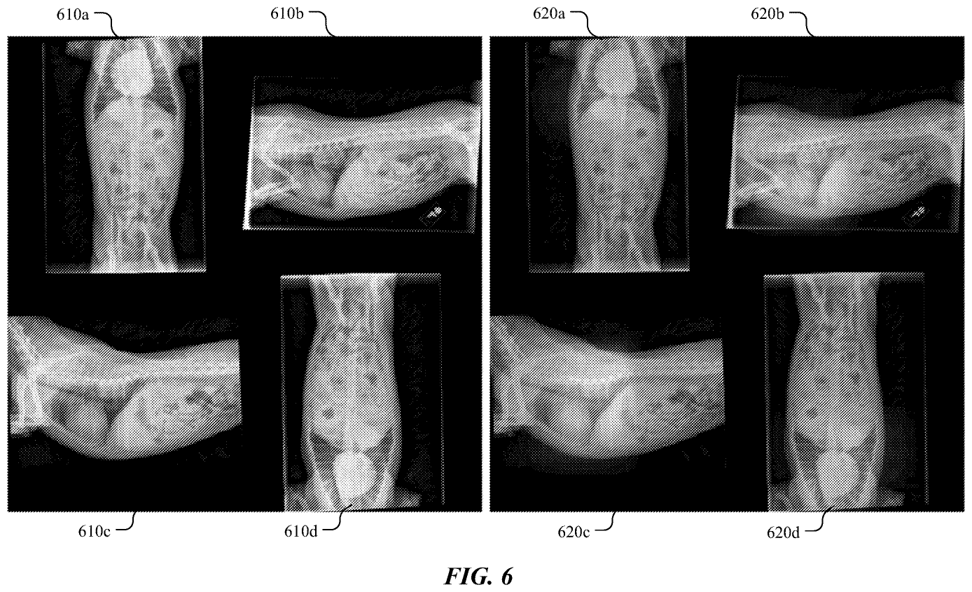

FIG. 6 illustrates an example attention map focusing on the thorax. The input X-ray images 610a, 610b, 610c, and 610d depict the body part of the thorax from different views. For the view on the bottom left (i.e., image 610c), the view was created from the first image 610a, with some data augmentation as there were initially only three views in the study. The attention maps are visualized in images 620a, 620b, 620c, and 620d, respectively. It can be seen that the attention is focused on the thorax in which the lungs are located, as expected.

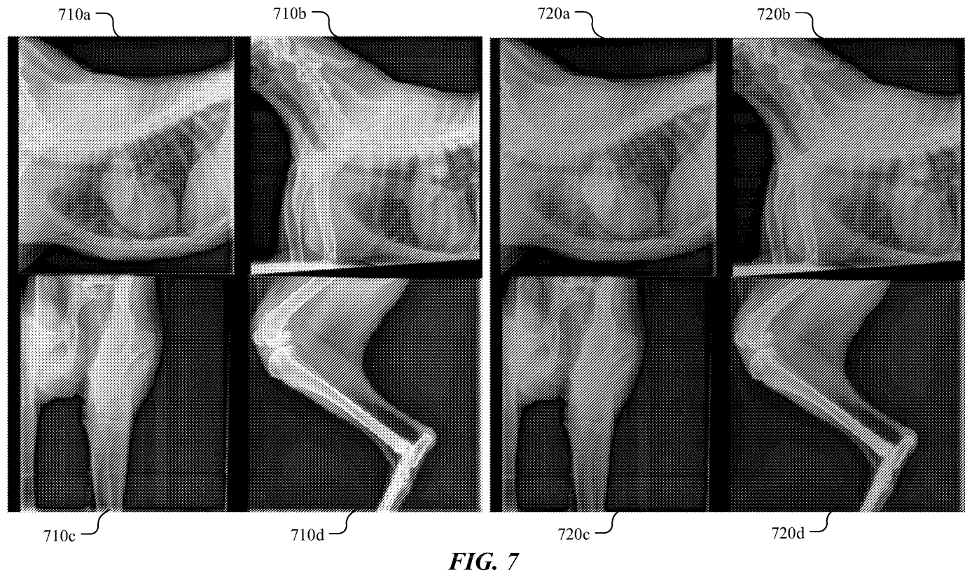

FIG. 7 illustrates another example attention map. The input X-ray images 710a, 710b, 710c, and 710d depict the body part of the lung from different views. The attention maps are visualized in images 720a, 720b, 720c, and 720d, respectively. The third image 720c and fourth image 720d do not show the lungs area, which may indicate that the vision transformer does not pay attention to these images, as expected.

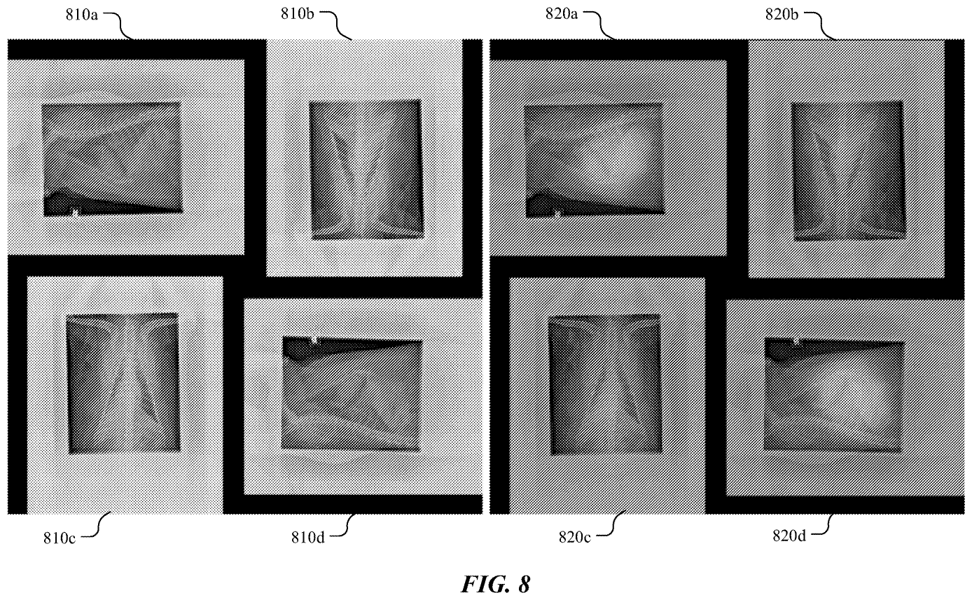

FIG. 8 illustrates another example attention map. The input X-ray images 810a, 810b, 810c, and 810d depict the body part of the thorax from different views. The attention maps are visualized in images 820a, 820b, 820c, and 820d, respectively. In this study, the context of the images is different. This may not disturb the focus of the vision transformer, which is still on the thorax area. As can be seen, vision transformers may be robust. The attention maps show that the vision transformer focuses on the thorax region where the lungs are located, as expected. The results also demonstrate that the vision transformer remains focused on the thorax area even with different contexts in the X-ray images. This may highlight the robustness of vision transformers.

The experimental results demonstrate that the model architecture disclosed herein can outperform single view based architectures in terms of classification performance. The results also show that the model disclosed herein, with its unique architecture that allows a variable number of views to be input in an arbitrary order, can perform better than the adapted network in MVCNN under the tested conditions and hyper-parameters.

The visualization of the vision transformer (ViT) attention maps can support the conclusion that the attention is focused on the correct regions in the images and highlight the robustness of the network. This finding may be particularly relevant for medical imaging, where the focus on specific regions of the images can be critical for accurate diagnosis.

Furthermore, it can be observed that using a network specific to a certain group of labels, as in the case with the network specific to lung diseases, may lead to improved performance. This conclusion may highlight the potential for specializing networks for specific domains to achieve better results.

In summary, the disclosed subject matter can contribute to the advancement of multi-view networks and shed light on the potential of using domain-specific networks for medical image classification.

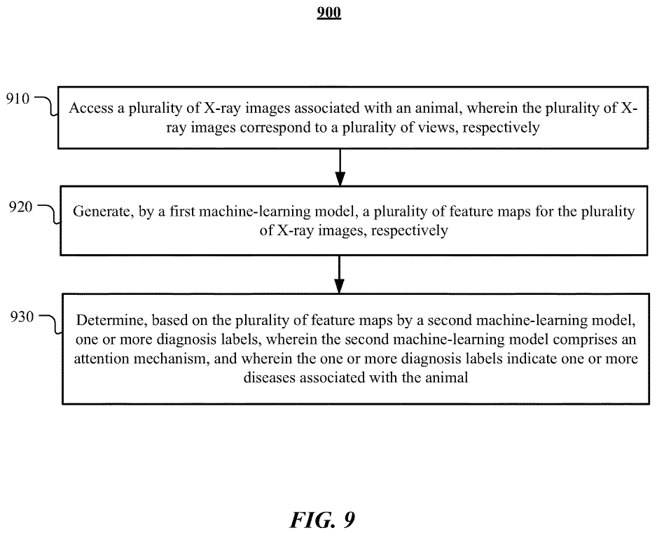

FIG. 9 illustrates an example method 900 for multi-view classification of X-ray images. The method may begin at step 910, where the computing system can access a plurality of X-ray images associated with an animal, wherein the plurality of X-ray images correspond to a plurality of views, respectively. At step 920, the computing system can generate, by a first machine-learning model, a plurality of feature maps for the plurality of X-ray images, respectively. At step 930, the computing system can determine, based on the plurality of feature maps by a second machine-learning model, one or more diagnosis labels, wherein the second machine-learning model comprises an attention mechanism, and wherein the one or more diagnosis labels indicate one or more diseases associated with the animal. Particular embodiments may repeat one or more steps of the method of FIG. 9, where appropriate. Although this disclosure describes and illustrates particular steps of the method of FIG. 9 as occurring in a particular order, this disclosure contemplates any suitable steps of the method of FIG. 9 occurring in any suitable order. Moreover, although this disclosure describes and illustrates an example method for multi-view classification of X-ray images including the particular steps of the method of FIG. 9, this disclosure contemplates any suitable method for multi-view classification of X-ray images including any suitable steps, which may include all, some, or none of the steps of the method of FIG. 9, where appropriate. Furthermore, although this disclosure describes and illustrates particular components, devices, or systems carrying out particular steps of the method of FIG. 9, this disclosure contemplates any suitable combination of any suitable components, devices, or systems carrying out any suitable steps of the method of FIG. 9.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure can be implemented in many manners and as such are not to be limited by the foregoing exemplary embodiments and examples. In other words, functional elements being performed by single or multiple components, in various combinations of hardware and software or firmware, and individual functions, can be distributed among software applications at either the client level or server level or both. In this regard, any number of the features of the different embodiments described herein can be combined into single or multiple embodiments, and alternate embodiments having fewer than, or more than, all of the features described herein are possible.

Functionality can also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that can be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications can be made to the elements and operations described above to obtain a result that remains within the scope of the systems and processes described in this disclosure.

While the disclosed subject matter is described herein in terms of certain preferred embodiments, those skilled in the art will recognize that various modifications and improvements can be made to the disclosed subject matter without departing from the scope thereof. Moreover, although individual features of one non-limiting embodiment of the disclosed subject matter can be discussed herein or shown in the drawings of the one non-limiting embodiment and not in other embodiments, it should be apparent that individual features of one non-limiting embodiment can be combined with one or more features of another embodiment or features from a plurality of embodiments.

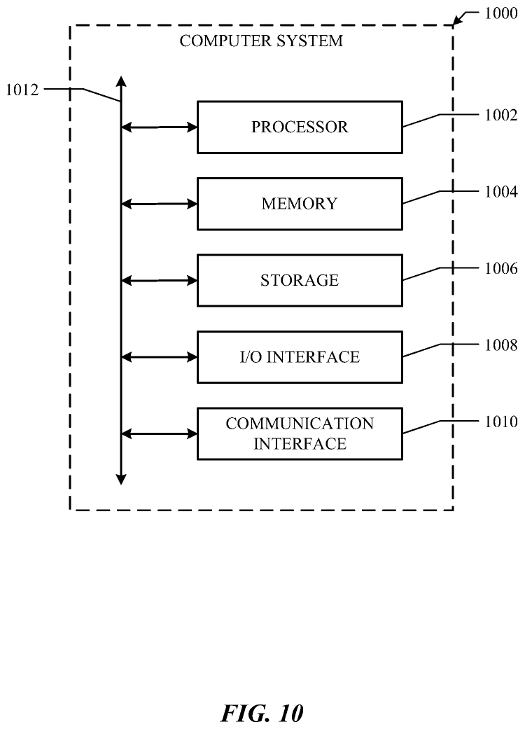

FIG. 10 illustrates an example computer system 1000. In particular embodiments, one or more computer systems 1000 perform one or more steps of one or more methods described or illustrated herein. In particular embodiments, one or more computer systems 1000 provide functionality described or illustrated herein. In particular embodiments, software running on one or more computer systems 1000 performs one or more steps of one or more methods described or illustrated herein or provides functionality described or illustrated herein. Particular embodiments include one or more portions of one or more computer systems 1000. Herein, reference to a computer system may encompass a computing device, and vice versa, where appropriate. Moreover, reference to a computer system may encompass one or more computer systems, where appropriate.

This disclosure contemplates any suitable number of computer systems 1000. This disclosure contemplates computer system 1000 taking any suitable physical form. As example and not by way of limitation, computer system 1000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1000 may include one or more computer systems 1000; be unitary or distributed; span multiple locations; span multiple machines; span multiple data centers; or reside in a cloud, which may include one or more cloud components in one or more networks. Where appropriate, one or more computer systems 1000 may perform without substantial spatial or temporal limitation one or more steps of one or more methods described or illustrated herein. As an example and not by way of limitation, one or more computer systems 1000 may perform in real time or in batch mode one or more steps of one or more methods described or illustrated herein. One or more computer systems 1000 may perform at different times or at different locations one or more steps of one or more methods described or illustrated herein, where appropriate.

In particular embodiments, computer system 1000 includes a processor 1002, memory 1004, storage 1006, an input/output (I/O) interface 1008, a communication interface 1010, and a bus 1012. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage 1006; decode and execute them; and then write one or more results to an internal register, an internal cache, memory 1004, or storage 1006. In particular embodiments, processor 1002 may include one or more internal caches for data, instructions, or addresses. This disclosure contemplates processor 1002 including any suitable number of any suitable internal caches, where appropriate. As an example and not by way of limitation, processor 1002 may include one or more instruction caches, one or more data caches, and one or more translation lookaside buffers (TLBs). Instructions in the instruction caches may be copies of instructions in memory 1004 or storage 1006, and the instruction caches may speed up retrieval of those instructions by processor 1002. Data in the data caches may be copies of data in memory 1004 or storage 1006 for instructions executing at processor 1002 to operate on; the results of previous instructions executed at processor 1002 for access by subsequent instructions executing at processor 1002 or for writing to memory 1004 or storage 1006; or other suitable data. The data caches may speed up read or write operations by processor 1002. The TLBs may speed up virtual-address translation for processor 1002. In particular embodiments, processor 1002 may include one or more internal registers for data, instructions, or addresses. This disclosure contemplates processor 1002 including any suitable number of any suitable internal registers, where appropriate. Where appropriate, processor 1002 may include one or more arithmetic logic units (ALUs); be a multi-core processor; or include one or more processors 1002. Although this disclosure describes and illustrates a particular processor, this disclosure contemplates any suitable processor.

In particular embodiments, memory 1004 includes main memory for storing instructions for processor 1002 to execute or data for processor 1002 to operate on. As an example and not by way of limitation, computer system 1000 may load instructions from storage 1006 or another source (such as, for example, another computer system 1000) to memory 1004. Processor 1002 may then load the instructions from memory 1004 to an internal register or internal cache. To execute the instructions, processor 1002 may retrieve the instructions from the internal register or internal cache and decode them. During or after execution of the instructions, processor 1002 may write one or more results (which may be intermediate or final results) to the internal register or internal cache. Processor 1002 may then write one or more of those results to memory 1004. In particular embodiments, processor 1002 executes only instructions in one or more internal registers or internal caches or in memory 1004 (as opposed to storage 1006 or elsewhere) and operates only on data in one or more internal registers or internal caches or in memory 1004 (as opposed to storage 1006 or elsewhere). One or more memory buses (which may each include an address bus and a data bus) may couple processor 1002 to memory 1004. Bus 1012 may include one or more memory buses, as described below. In particular embodiments, one or more memory management units (MMUs) reside between processor 1002 and memory 1004 and facilitate accesses to memory 1004 requested by processor 1002. In particular embodiments, memory 1004 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1004 may include one or more memories 1004, where appropriate. Although this disclosure describes and illustrates particular memory, this disclosure contemplates any suitable memory.

In particular embodiments, storage 1006 includes mass storage for data or instructions. As an example and not by way of limitation, storage 1006 may include a hard disk drive (HDD), a floppy disk drive, flash memory, an optical disc, a magneto-optical disc, magnetic tape, or a Universal Serial Bus (USB) drive or a combination of two or more of these. Storage 1006 may include removable or non-removable (or fixed) media, where appropriate. Storage 1006 may be internal or external to computer system 1000, where appropriate. In particular embodiments, storage 1006 is non-volatile, solid-state memory. In particular embodiments, storage 1006 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1006 taking any suitable physical form. Storage 1006 may include one or more storage control units facilitating communication between processor 1002 and storage 1006, where appropriate. Where appropriate, storage 1006 may include one or more storages 1006. Although this disclosure describes and illustrates particular storage, this disclosure contemplates any suitable storage.

In particular embodiments, I/O interface 1008 includes hardware, software, or both, providing one or more interfaces for communication between computer system 1000 and one or more I/O devices. Computer system 1000 may include one or more of these I/O devices, where appropriate. One or more of these I/O devices may enable communication between a person and computer system 1000. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1008 for them. Where appropriate, I/O interface 1008 may include one or more device or software drivers enabling processor 1002 to drive one or more of these I/O devices. I/O interface 1008 may include one or more I/O interfaces 1008, where appropriate. Although this disclosure describes and illustrates a particular I/O interface, this disclosure contemplates any suitable I/O interface.

In particular embodiments, communication interface 1010 includes hardware, software, or both providing one or more interfaces for communication (such as, for example, packet-based communication) between computer system 1000 and one or more other computer systems 1000 or one or more networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1010 for it. As an example and not by way of limitation, computer system 1000 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1000 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1000 may include any suitable communication interface 1010 for any of these networks, where appropriate. Communication interface 1010 may include one or more communication interfaces 1010, where appropriate. Although this disclosure describes and illustrates a particular communication interface, this disclosure contemplates any suitable communication interface.

In particular embodiments, bus 1012 includes hardware, software, or both coupling components of computer system 1000 to each other. As an example and not by way of limitation, bus 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1012 may include one or more buses 1012, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

1. A method comprising, by one or more computing systems:
accessing a plurality of three-dimensional (3D) X-ray images associated with an animal, wherein the plurality of 3D X-ray images correspond to a plurality of views, respectively;
generating, by a first machine-learning model comprising one or more convolutional neural networks, a plurality of 3D feature maps for the plurality of 3D X-ray images, respectively, wherein the plurality of 3D feature maps correspond to the plurality of views, respectively;
generating, based on one or more data augmentation mechanisms, one or more additional 3D feature maps from the plurality of 3D feature maps;
generating an integrated 3D feature map based on the plurality of 3D feature maps and the one or more additional 3D feature maps;
inputting the integrated 3D feature map to a second machine-learning model comprising one or more adapted vision transformers configured for processing 3D inputs;
modeling, by the second machine-learning model, a contextual relationship associated with the integrated 3D feature map based on a self-attention mechanism associated with the second machine-learning model;
determining, by the second machine-learning model based on the integrated 3D feature map and the contextual relationship associated with the integrated 3D feature map, one or more diagnosis labels, wherein the one or more diagnosis labels indicate one or more diseases associated with the animal; and
generating one or more attention maps for the plurality of 3D X-ray images, wherein each of the one or more attention maps highlights a focused region indicating a disease from the one or more diseases associated with the one or more diagnosis labels.

2. The method of claim 1, wherein the plurality of 3D X-ray images depict one or more organs of the animal.

3. The method of claim 1, wherein the one or more diagnosis labels comprise one or more of pulmonary mass, pulmonary interstitial nodule, or mediastinal mass effect.

4. A method comprising, by one or more computing systems:
accessing a plurality of X-ray images associated with an animal, wherein the plurality of X-ray images correspond to a plurality of views, respectively;
generating, by a first machine-learning model, a plurality of feature maps for the plurality of X-ray images, respectively; and
determining, based on the plurality of feature maps by a second machine-learning model, one or more diagnosis labels, wherein the second machine-learning model comprises an attention mechanism, and wherein the one or more diagnosis labels indicate one or more diseases associated with the animal.

5. The method of claim 4, wherein the plurality of X-ray images depict one or more organs of the animal.

6. The method of claim 4, wherein the first machine-learning model is based on one or more convolutional neural networks.

7. The method of claim 4, wherein the second machine-learning model is based on one or more vision transformers.

8. The method of claim 4, further comprising:
generating, based on data augmentation, one or more additional feature maps from the plurality of feature maps.

9. The method of claim 4, further comprising:
concatenating the feature maps to form a tensor; and
inputting the tensor to the second machine-learning model.

10. The method of claim 4, wherein the second machine-learning model is based on one or more loss functions comprising one or more of a binary cross entropy or a focal loss.

11. The method of claim 4, wherein the one or more diagnosis labels comprise one or more of pulmonary mass, pulmonary interstitial nodule, or mediastinal mass effect.

12. The method of claim 4, further comprising:
generating one or more attention maps for the plurality of X-ray images, wherein each of the one or more attention maps highlights a focused region indicating a disease.

13. One or more computer-readable non-transitory storage media embodying software that is operable when executed to:
access a plurality of X-ray images associated with an animal, wherein the plurality of X-ray images correspond to a plurality of views, respectively;
generate, by a first machine-learning model, a plurality of feature maps for the plurality of X-ray images, respectively; and
determine, based on the plurality of feature maps by a second machine-learning model, one or more diagnosis labels, wherein the second machine-learning model comprises an attention mechanism, and wherein the one or more diagnosis labels indicate one or more diseases associated with the animal.

14. The media of claim 13, wherein the plurality of X-ray images depict one or more organs of the animal.

15. The media of claim 13, wherein the first machine-learning model is based on one or more convolutional neural networks.

16. The media of claim 13, wherein the second machine-learning model is based on one or more vision transformers.

17. The media of claim 13, wherein the software is further operable when executed to:
concatenate the feature maps to form a tensor; and
input the tensor to the second machine-learning model.

18. The media of claim 13, wherein the second machine-learning model is based on one or more loss functions comprising one or more of a binary cross entropy or a focal loss.

19. The media of claim 13, wherein the one or more diagnosis labels comprise one or more of pulmonary mass, pulmonary interstitial nodule, or mediastinal mass effect.

20. The media of claim 13, wherein the software is further operable when executed to:
generate one or more attention maps for the plurality of X-ray images, wherein each of the one or more attention maps highlights a focused region indicating a disease.

21.-28. (canceled)
